(19) United States
(12) Patent Application Publication
(10) Pub. No.: US 2013/0329899 A1
(43) Pub. Date: Dec. 12, 2013

(54) MEASURING APPARATUS AND COMPUTER PROGRAM

(71) Applicant: KABUSHIKI KAISHA TOSHIBA, Tokyo (JP)

(72) Inventors: Kimio Miseki, Ome-shi (JP); Tadashi Amada, Ome-shi (JP); Toshifumi Yamamoto, HIno-shi (JP)

(73) Assignee: KABUSHIKI KAISHA TOSHIBA, Tokyo (JP)

(21) Appl. No.: 13/778,484

(22) Filed: Feb. 27, 2013

(30) Foreign Application Priority Data
Jun. 7, 2012 (JP) 2012-130090

(51) Int. Cl. H04R 29/00

(52) U.S. Cl. CPC H04R 29/001
USPC 381/59

(57) ABSTRACT

According to one embodiment, a measuring apparatus includes: an output module configured to temporally exclusively output, to a measuring target system, a first output signal corresponding to a first measuring signal for sweeping frequency and a second output signal corresponding to a second measuring signal for sweeping frequency and having a different amplitude characteristic from an amplitude characteristic of the first measuring signal; and a frequency characteristic computation module configured to synthesize a first frequency amplitude spectrum obtained from a first reception signal when a sound output from the measuring target system based on the first output signal is received and a second frequency amplitude spectrum obtained from a second reception signal when a sound output from the measuring target system based on the second output signal is received to generate frequency characteristic data representing an acoustic characteristic.

### CROSS-REFERENCE TO RELATED APPLICATIONS

This application is based upon and claims the benefit of priority from Japanese Patent Application No. 2012-130090, filed on Jun. 7, 2012, the entire contents of which are incorporated herein by reference.

### FIELD

An embodiment described herein relates generally to a measuring apparatus and a computer program.

### BACKGROUND

Sinusoidal sweep signals whose frequencies continuously change with time are often used as measuring signals for measuring impulse responses and frequency characteristics. A time stretched pulse (TSP) signal is a representative of the sinusoidal sweep signals and has a feature that it enables measurement using a time domain signal having a maximum amplitude performed over all frequencies. As a result, the TSP signal is a suitable measuring signal for a measuring target system having almost a flat frequency characteristic (e.g., a speaker), for example. However, when the TSP signal is used for a measuring target system having no flat frequency characteristic (e.g., in a case where an earphone is measured directly by a microphone), a band range in which a gain of the measuring target system is low is readily buried in noise, thereby reducing accuracy of a measurement result. When measurement is performed using a louder sound by increasing output power of the measuring signal or a gain of a receiving module, the signal exceeds a maximum of a receiving level in a band range in which the gain of the measuring target system is high and is thus distorted, thereby causing incorrect measurement of the signal.

In a related-art measuring method, measurements sometimes result in low accuracy when the impulse response and the frequency characteristic of a measuring target system that comprises an output device (a sound-isolating earphone) and a receiving device (a microphone) and whose frequency characteristic of a reception signal is not flat, are measured over all frequencies using the TSP signal, which is a time domain signal having a maximum amplitude.

More specifically, when a level of the frequency characteristic greatly varies in band range in the measuring target system, the accuracy of the measurement result is reduced as follows. When a sound volume level of a reproduction signal is adjusted based on a band range in which an amplitude level is low (low band range of the sound-isolating earphone), the reception signal in a band range in which the amplitude level is high (high band range of the sound-isolating earphone) overflows. In contrast, when the sound volume level of the reproduction signal is adjusted based on the band range in which the amplitude level is high, a signal in the band range in which the amplitude level is low causes a drop in accuracy of the reproduction signal due to quantization distortion and a drop in the receiving level.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view illustrating a computer according to an embodiment in a state where a display unit thereof is opened;

FIG. 2 is an exemplary block diagram illustrating a system structure of the computer in the embodiment;

FIG. 3 is an exemplary block diagram illustrating a functional structure for measuring a frequency characteristic in the embodiment;

FIG. 4 is an exemplary graph illustrating the frequency characteristic of a sound in the embodiment;

FIG. 5 is an exemplary schematic diagram illustrating a waveform after a TSP signal is inverse Fourier transformed in the embodiment;

FIG. 6 is an exemplary schematic diagram illustrating an amplitude spectrum of a sound output from an earphone to which the TSP signal illustrated in FIG. 5 is input in the embodiment;

FIG. 7 is an exemplary schematic diagram illustrating a frequency amplitude spectrum obtained by Fourier transforming the waveform illustrated in FIG. 6 in the embodiment;

FIG. 8 is an exemplary schematic diagram illustrating the amplitude spectrum of a reception signal when an output sound from the earphone is measured in the embodiment;

FIG. 9 is an exemplary schematic diagram illustrating the frequency amplitude spectrum of an impulse response obtained from the spectrum illustrated in FIG. 8 in the embodiment;

FIG. 10 is an exemplary schematic diagram illustrating the amplitude spectrum of the reception signal when a sound volume of a reproduction signal is increased in the embodiment;

FIG. 11 is an exemplary schematic diagram illustrating the amplitude spectrum of a measuring signal when the TSP signal is weighted in the embodiment;

FIG. 12 is an exemplary schematic diagram illustrating a weight coefficient W(k) used when the TSP signal illustrated in FIG. 11 is produced and 1/W(k) used when an inverse TSP signal of the TSP signal is produced in the embodiment;

FIG. 13 is an exemplary schematic diagram illustrating the amplitude spectrum of the reception signal when the output sound from the earphone is measured using the TSP signal illustrated in FIG. 11 in the embodiment;

FIG. 14 is an exemplary schematic diagram illustrating the amplitude spectrum of the reception signal when the output sound from the earphone is measured using the TSP signal illustrated in FIG. 11 while a reproduction sound volume or a receiving sound volume is increased in the embodiment;

FIG. 15 is an exemplary schematic diagram illustrating the frequency amplitude spectrum of the impulse response obtained from the spectrum illustrated in FIG. 14 in the embodiment;

FIG. 16 is an exemplary schematic diagram illustrating the amplitude spectrum of the measuring signal when the amplitude of the TSP signal illustrated in FIG. 11 is controlled to be flat in a predetermined range in a low frequency range and a high frequency range in the embodiment;

FIG. 17 is an exemplary schematic diagram illustrating the amplitude spectrum of the measuring signal when the TSP signal is weighted in the embodiment;

FIG. 18 is an exemplary schematic diagram illustrating the amplitude spectrum of the measuring signal, which is the TSP signal in which the amplitude in a low range is emphasized relative to the amplitude in a high range in the embodiment;

FIG. 19 is an exemplary schematic diagram illustrating the amplitude spectrum of the measuring signal, which is the TSP signal in which the amplitude in the low range is emphasized relative to the amplitude in the high band range in the embodiment;

FIGS. 20A to 20C are exemplary schematic diagrams illustrating synthesizing of the frequency amplitude spectrums in a frequency characteristic computation module in the embodiment;

FIG. 21 is an exemplary block diagram illustrating a structure of a correction function of a media player in the embodiment;

FIG. 22 is an exemplary graph illustrating the frequency characteristic represented by a target characteristic in the embodiment;

FIG. 23 is an exemplary graph illustrating the frequency characteristic represented by a correction filter in the embodiment;

FIG. 24 is an exemplary graph illustrating the frequency characteristic of a sound output from a sound-isolating earphone in the embodiment; and

FIG. 25 is an exemplary flowchart illustrating a procedure of measurement of the frequency characteristic of a sound and correction of the sound to be output in the embodiment.

### DETAILED DESCRIPTION

In general, according to one embodiment, a measuring apparatus comprises: an output module configured to temporally exclusively output, to a measuring target system, a first output signal corresponding to a first measuring signal for sweeping frequency and a second output signal corresponding to a second measuring signal for sweeping frequency and having a different amplitude characteristic from an amplitude characteristic of the first measuring signal; and a frequency characteristic computation module configured to synthesize a first frequency amplitude spectrum obtained from a first reception signal when a sound output from the measuring target system based on the first output signal is received and a second frequency amplitude spectrum obtained from a second reception signal when a sound output from the measuring target system based on the second output signal is received to generate frequency characteristic data representing an acoustic characteristic.

An embodiment is described below with reference to the accompanying drawings.

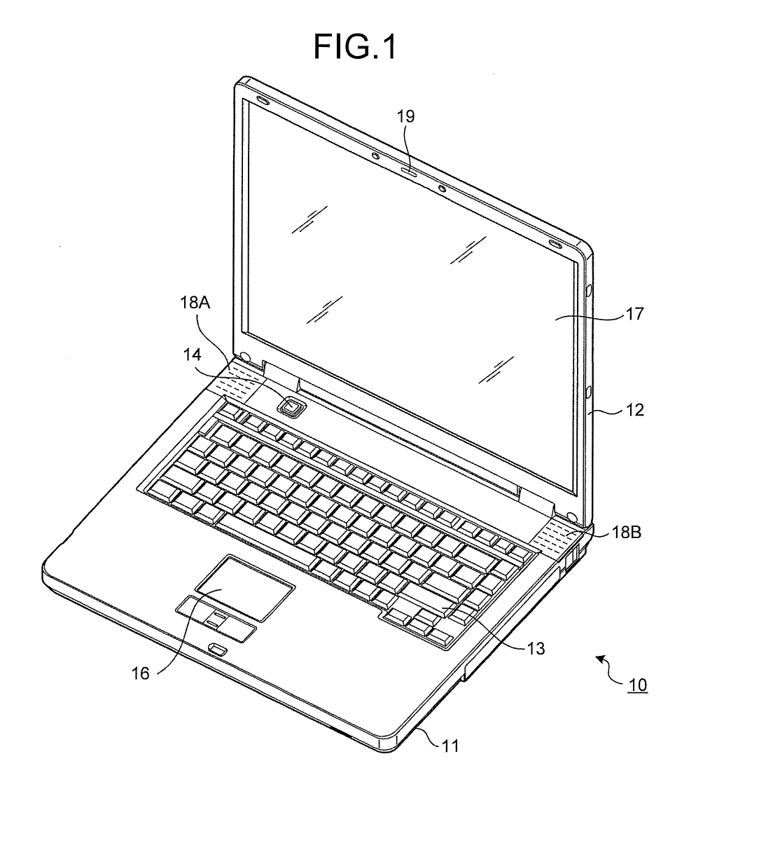

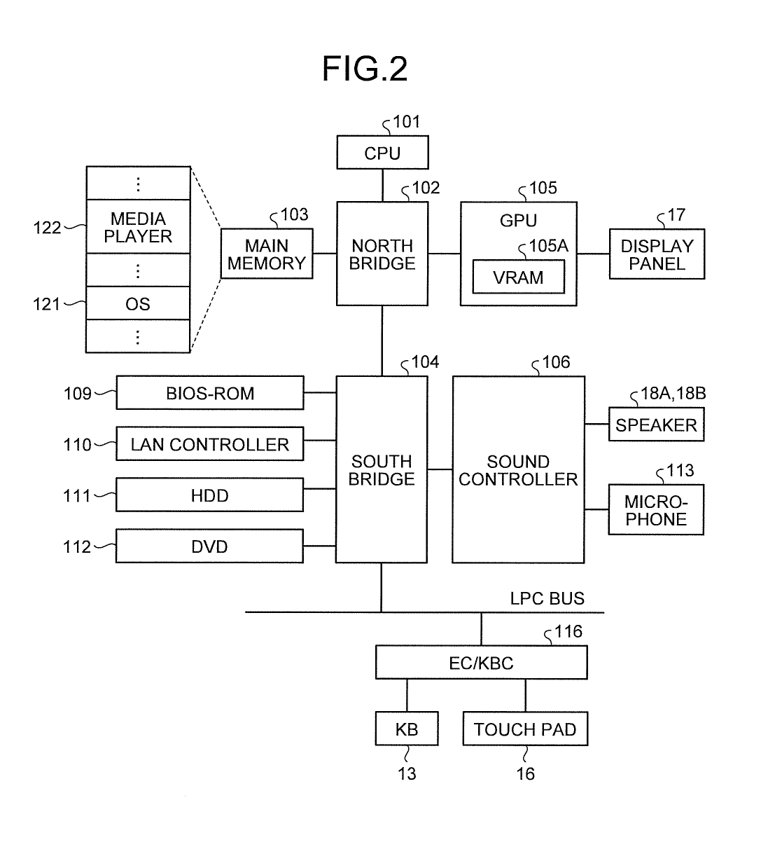

A structure of a measuring apparatus (reproducing apparatus) is described with reference to FIGS. 1 and 2. The measuring apparatus (reproducing apparatus) of the embodiment is achieved by a notebook portable personal computer, for example.

FIG. 1 is a perspective view of a notebook portable personal computer 10 in a state where a display unit thereof is opened. The notebook portable personal computer 10 (hereinafter referred to as the computer 10) comprises a computer body 11 and a display unit 12.

A display panel 17 having a liquid crystal panel is built into the display unit 12. A microphone 113 (refer to FIG. 2) is provided inside the display unit 12. The display unit 12 is provided with a microphone hole 19 such that the microphone 113 can efficiently collect sounds.

The display unit 12 is mounted on the computer body 11 so as to be rotatable between an open position at which the display unit 12 causes an upper surface of the computer body 11 to be exposed and a closed position at which the display unit 12 covers the upper surface of the computer body 11. The computer body 11 has a thin box-shaped housing, on an upper surface of which a keyboard 13, a power button 14 to power on or power off the computer 10, a touch pad 16, and speakers 18A and 18B are disposed, for example.

A system structure of the computer 10 is described below with reference to FIG. 2. As illustrated in FIG. 2, the computer 10 comprises a central processing unit (CPU) 101, a north bridge 102, a main memory 103, a south bridge 104, a graphics processing unit (GPU) 105, a video memory (VRAM) 105A, a sound controller 106, a basic input output system (BIOS)-read only memory (ROM) 109, a local area network (LAN) controller 110, a hard disk drive (HDD) 111, a digital versatile disc (DVD) drive 112, and an embedded controller/keyboard controller (EC/KBC) integrated circuit (IC) 116.

The CPU 101 is a processor for controlling the operation of the computer 10. The CPU 101 executes an operating system (OS) 121 and various application programs such as a media player 122, which are loaded from the HDD 111 to the main memory 103. The media player 122 is application software to reproduce moving picture (video) files and audio files. The CPU 101 also executes a BIOS stored in the BIOS-ROM 109. The BIOS is a computer program for hardware control.

The north bridge 102 is a bridge device coupling a local bus of the CPU 101 with the south bridge 104. The north bridge 102 comprises a memory controller to control access to the main memory 103. The north bridge 102 also has a function to communicate with the GPU 105 through a serial bus compliant with the peripheral components interconnection (PCI) EXPRESS standard, for example.

The GPU 105 is a display controller that controls the display panel 17 used as a display monitor of the computer 10. The GPU 105 uses the VRAM 105A as a working memory. A video signal produced by the GPU 105 is transmitted to the display panel 17.

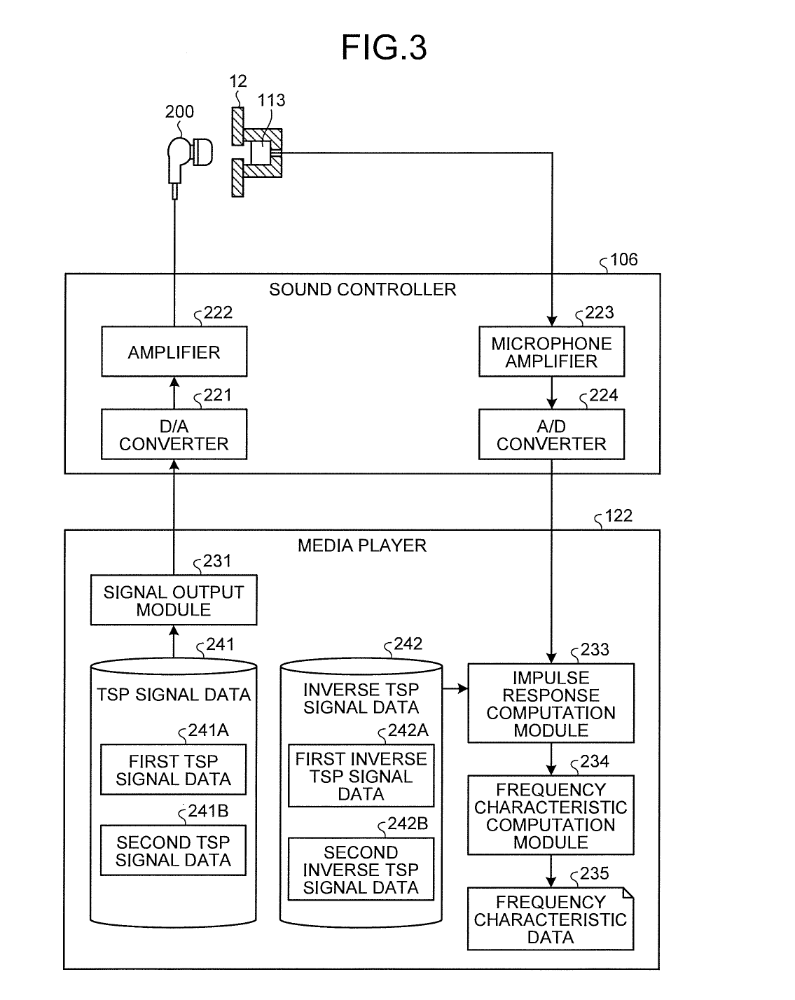

The south bridge 104 controls each device on a low pin count (LPC) bus and each device on a peripheral component interconnect (PCI) bus. The south bridge 104 controls the LAN controller 110 to activate a LAN function. The south bridge 104 comprises an integrated drive electronics (IDE) controller to control the HDD 111 and the DVD drive 112. The south bridge 104 also has a function to communicate with the sound controller 106. The sound controller 106, which is a sound source device, comprises circuits such as a digital-to-analog (D/A) converter 221 (refer to FIG. 3) that converts a digital signal into an electrical signal and an amplifier 222 (refer to FIG. 3) that amplifies the electrical signal, in order to output audio data, which are a reproduction target, to the speakers 18A and 18B. In addition, the sound controller 106 comprises circuits such as a microphone amplifier 223 (refer to FIG. 3) that amplifies an electrical signal input from the microphone 113 and an analog-to-digital (A/D) converter 224 (refer to FIG. 3) that converts the amplified electrical signal into a digital signal.

The EC/KBC IC 116 is a one-chip microcomputer in which an embedded controller for power control and a keyboard controller for controlling the keyboard (KB) 13 and the touch pad 16 are integrated. The EC/KBC IC 116 has a function to power on or power off the computer 10 in response to user's operation on the power button 14.

A function of the media player 122 is described below. The media player 122 has a function to measure an impulse response and a frequency characteristic of a sound output from a sound-isolating earphone 200 (refer to FIG. 3). A structure for measuring the frequency characteristic is described with reference to FIG. 3.

As illustrated in FIG. 3, the sound controller 106 comprises the D/A converter (digital-to-analog conversion circuit) 221, the amplifier 222, the microphone amplifier 223, and the A/D converter (analog-to-digital conversion circuit) 224.

The media player 122 comprises a signal output module 231, an impulse response computation module 233 and a frequency characteristic computation module 234.

The signal output module 231 outputs an output signal corresponding to TSP signal data 241, which is digital data, stored in the HDD 111 to the D/A converter 221, for example.

The D/A converter 221 converts the output signal corresponding to the TSP signal data 241 into an analog measuring signal. The converted analog measuring signal is amplified by the amplifier 222 and the amplified analog measuring signal is supplied to the sound-isolating earphone 200. The sound-isolating earphone 200 outputs a sound corresponding to the supplied measuring signal.

The sound thus output from the sound-isolating earphone 200 is received by the microphone 113. The microphone 113 converts the received sound into an electrical measurement signal (reception signal) and supplies the measurement signal to the microphone amplifier 223. The microphone amplifier 223 amplifies the supplied measurement signal and supplies the amplified measurement signal to the A/D converter 224. The A/D converter 224 converts the measurement signal into digital data and outputs the converted measurement signal to the impulse response computation module 233.

The impulse response computation module 233 performs computation of an impulse response by convolving the measurement signal with inverse TSP signal data 242, which is obtained by inverting the TSP signal data 241 in chronological order (by performing convolution computation on the measurement signal and the inverse TSP signal data 242). It is well known that a computation amount of the impulse response by the convolution computation is sometimes reduced by calculating a product of the measurement signal and Fourier transform of the inverse TSP signal data 242. The inverse TSP signal data 242 is stored in the HDD 111, for example.

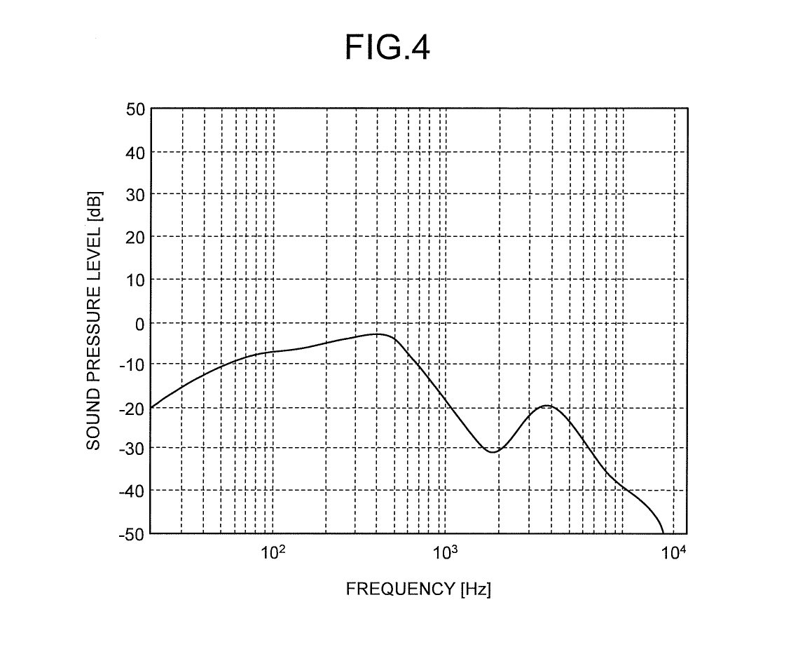

The impulse response computation module 233 supplies the resulting impulse response to the frequency characteristic computation module 234. The frequency characteristic computation module 234 performs computation of a frequency amplitude spectrum by Fourier transforming the impulse response and obtains frequency characteristic data 235. FIG. 4 illustrates an example of a frequency characteristic of a sound that is output from the sound-isolating earphone 200 and collected by the microphone 113.

It is necessary for high accuracy measurement that the amplifier 222 on a reproduction side is adjusted so as to cause the sound-isolating earphone 200 to output a sound with a proper sound volume while the microphone amplifier 223 on a receiving side is adjusted so as to use a dynamic range of the measurement signal as widely as possible.

The TSP signal, whose frequency continuously changes with time for sweeping frequency, is often used when characteristics of audio equipment are measured. There are various improved types of TSP signals. For example, a standard TSP signal and a Log-TSP signal whose frequency is logarithmically swept, i.e., the frequency sweep is slower as the frequency decreases in a low range, are defined as the following respective formulas in a frequency domain.

$$\begin{matrix}{H}_{TSP} ( k ) = \{ \begin{matrix}exp ( - j 4 m {πk}^{2} / {N}^{2} ) & ( 0 \leq k \leq N / 2 ) \\ {H}_{TSP}^{*} ( N - k ) & ( N / 2 < k < N )\end{matrix} & ( 1 ) \\ {H}_{Log - TSP} ( k ) = \{ \begin{matrix}\frac{\begin{matrix}1 \\ exp ( - jak log ( k ) )\end{matrix}}{\begin{matrix}\sqrt{k} \\ {H}_{Log - TSP}^{*} ( N - k )\end{matrix}} & \begin{matrix}( k = 0 ) \\ \begin{matrix}( 1 \leq k < N / 2 ) \\ ( N / 2 < k < N )\end{matrix}\end{matrix}\end{matrix} & ( 2 )\end{matrix}$$

where a=2mπ/(N/2)log(N/2), m is an integer, N is the signal length of the TSP or Log-TSP signal, m is the parameter determining the pulse width, k is the parameter determining the frequency, and superscript star * presents complex conjugation.

The inverse TSP signal is defined as the complex conjugation of the TSP signal in the frequency domain. When the inverse TSP signal is used for measurement, Htsp(k) is inverse Fourier transformed so as to be transformed into a signal expressed in a time domain, and the converted signal is reproduced and used.

FIG. 5 is a schematic diagram illustrating a waveform obtained by inverse Fourier transforming Htsp(k). As illustrated in FIG. 5, the TSP signal is composed of a sine wave whose amplitude is constant and whose frequency changes continuously. In FIG. 5, the amplitude is exemplarily illustrated as a maximum value of 100% for simple explanation. However, it is better for practical use to set the amplitude to a value slightly lower than the maximum value taking, for example, a computation error into consideration. The output signal corresponding to the measuring signal is input to a measurement target system (the sound-isolating earphone 200) and the reception signal is obtained by observing the output of the measurement target system.

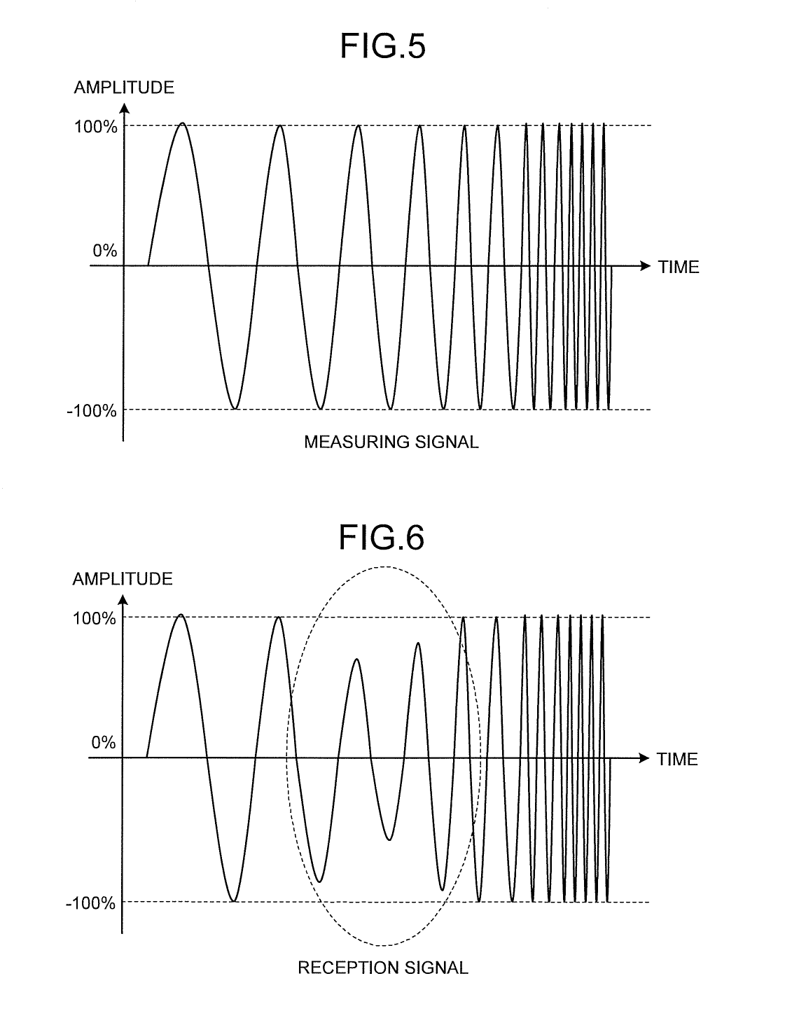

FIG. 6 illustrates an example of the reception signal. In the example illustrated in FIG. 6, the amplitude is lower than 100% near the central region but the amplitude is 100%, which is the same as that of a reproduction signal, in the other regions. The impulse response can be obtained by convolving the reception signal with the inverse TSP signal. In addition, the frequency amplitude spectrum, as illustrated in FIG. 7, can be obtained by inverse Fourier transforming the impulse response.

In FIG. 7, the level of the frequency at which the amplitude is observed as the same level as the input is represented as 0 (zero) dB. In the reception signal illustrated in FIG. 7, the amplitude of the frequency amplitude spectrum corresponding to the lower amplitude region near the central region of the reception signal of FIG. 6 is observed below 0 dB.

As described above, when the frequency characteristic of the sound-isolating earphone 200 is measured, the output signal corresponding to the measuring signal illustrated in FIG. 5 is reproduced by the media player 122, a sound output from the sound-isolating earphone 200 is acquired by the microphone 113, and the signal of the microphone 113 is convolved with the inverse TSP signal, thereby resulting in the impulse response and the frequency characteristic of the sound-isolating earphone 200 being obtained.

When an output sound of the sound-isolating earphone 200 is measured by placing the microphone 113 close to the sound-isolating earphone 200, the observed sound becomes smaller as the frequency decreases in the low range. This is due to the physical phenomenon that it is difficult to hear a lower tone when the measurement is performed in an open state because the sound-isolating earphone 200 is designed to take into consideration resonance in a closed state when the sound-isolating earphone 200 is put in an ear, for example. Such a system is called a high-pass system, herein.

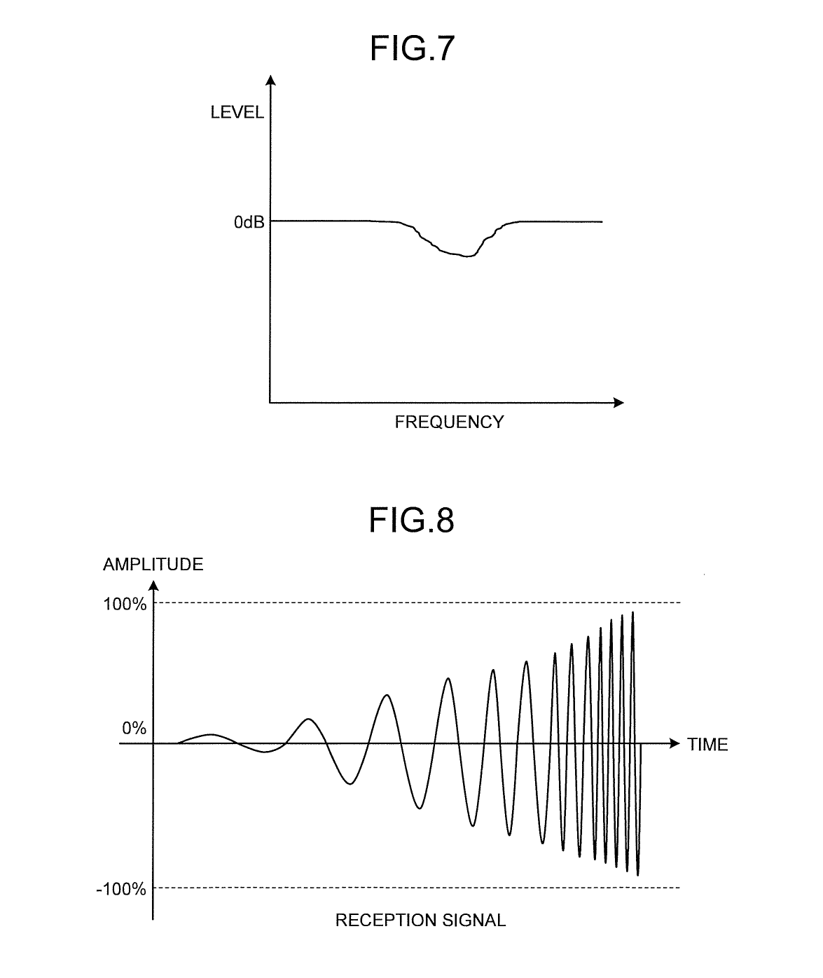

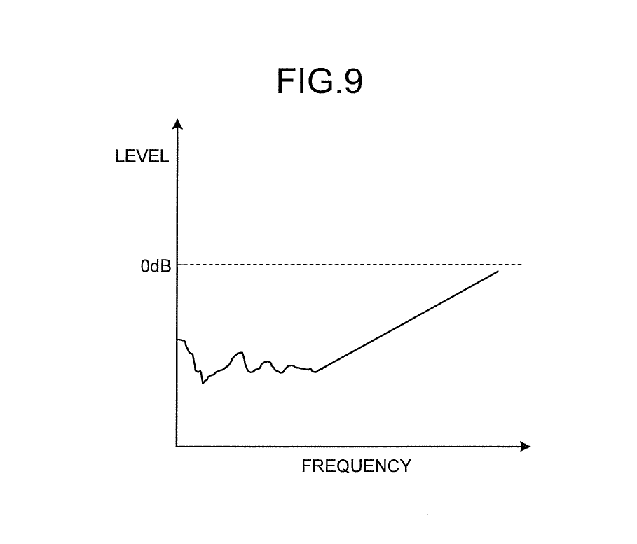

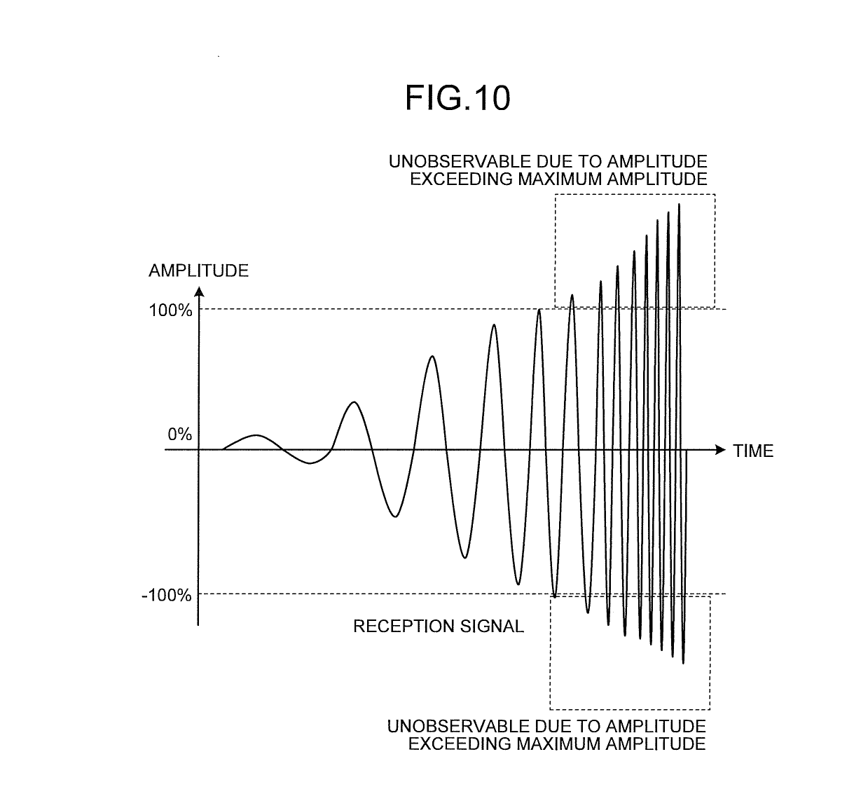

FIG. 8 illustrates a waveform of the reception signal of a sound that is output from the high-pass system and received by the microphone 113. As illustrated in FIG. 8, the amplitude in a low frequency range is observed extremely smaller than that in a high frequency range. The impulse response is produced by convolving the frequency amplitude spectrum illustrated in FIG. 8 with the inverse TSP signal. FIG. 9 illustrates the frequency amplitude spectrum of the produced impulse response. In the high frequency range, a sound volume of approximately 0 dB, which is the same level as that of the measuring signal, is obtained. The lower the frequency, the smaller the amplitude. When the amplitude is too small, the sound is buried in noise, and as a result, a correct measurement value is not obtained. When the sound volume of the reproduction signal is increased by the amplifier 222 or a gain of the microphone amplifier 223 is increased for increasing the level of the reception signal, the waveform of the reception signal is changed as illustrated in FIG. 10. In the high frequency range, a problem arises in that the amplitude exceeds the upper limit and the waveform is distorted. In order to solve these problems, TSP signals whose frequency components are weighted are used as measuring signals, in the embodiment. Specifically, a measuring signal M(k), which is obtained by multiplying H(k) of Formula (1) or (2) by a frequency weight W(k) as expressed by Formula (3).

$$M ( k ) = \{ \begin{matrix}H ( k ) \times W ( k ) & ( 0 \leq k \leq N / 2 ) \\ {M}^{*} ( N - k ) & ( N / 2 < k < N )\end{matrix} \qquad ( 3 )$$

The inverse TSP signal (Minv(k)) is defined by Formula (4).

$${M}_{inv} ( k ) = \{ \begin{matrix}{H}^{*} ( k ) / {W}^{*} ( k ) & ( 0 \leq k \leq N / 2 ) \\ {{M}_{inv}^{*}}^{ } ( N - k ) & ( N / 2 < k < N )\end{matrix} \qquad ( 4 )$$

The weight can be applied to TSP signals other than the aforementioned TSP signals and Log-TSP signals in the same manner as described above.

It is practical that the weight is experimentally determined. Several patterns of the amplitude of the reception signal are observed from several measurement target systems, and thereafter the weights of W(k)<1 are set to frequency components having a large amplitude. Ideally, an inverse characteristic of an average frequency amplitude spectrum of the measurement target system is set to W(k), thereby enabling the reception signal to be a signal having approximately no variation in amplitude.

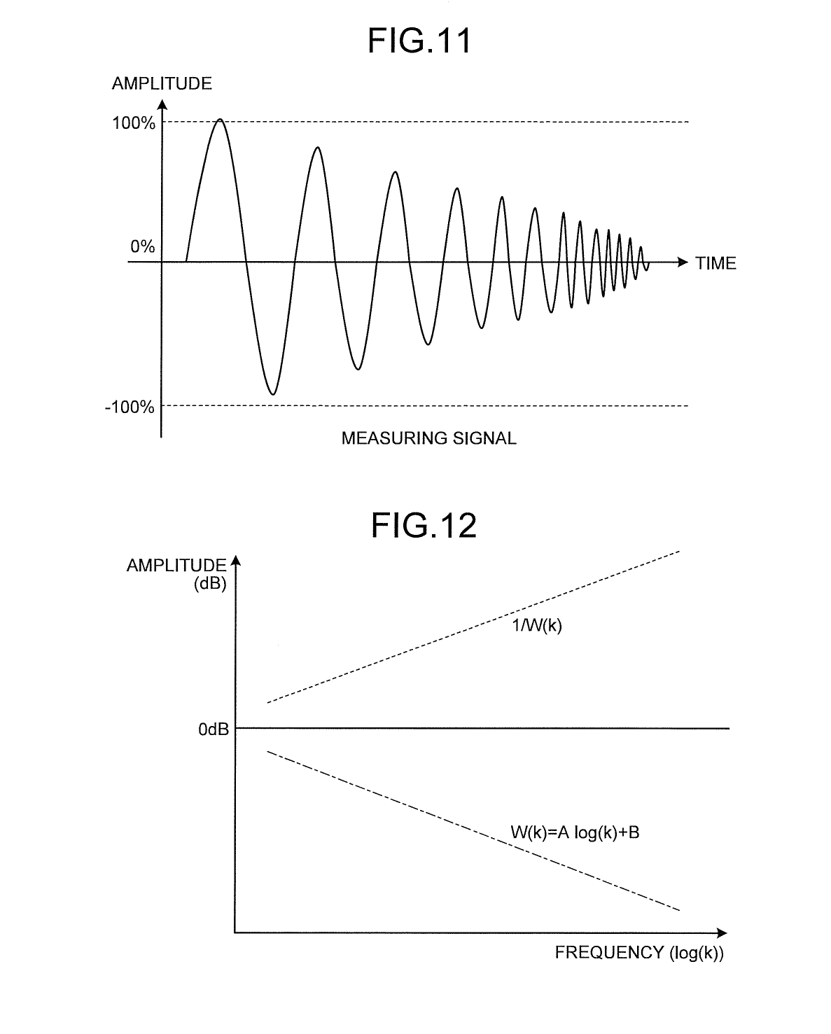

The measuring signal illustrated in FIG. 11 is an amplitude weighted TSP signal produced based on the design of W(k) for the high-pass system. The amplitude of the measuring signal is suppressed using W(k) having smaller value as the frequency increases in a high range in which the gain of the measurement target system is high.

FIG. 12 is a schematic diagram illustrating the weight coefficient W(k) used when the TSP signal illustrated in FIG. 11 is produced, and 1/W(k) used when the inverse TSP signal is produced. When it is known that the gain of the measurement target system increases as the frequency increases in the high frequency range, the weight illustrated as W(k) in FIG. 12 is multiplied by a value that decreases as the frequency increases, i.e., has an inverse characteristic of the gain of the measurement target system, thereby enabling the measurement to be performed with high accuracy from the low frequency range to the high frequency range. The weight 1/W(k) multiplied to the inverse TSP signal is designed so as to be symmetric to the weight W(k) with respect to 0 dB.

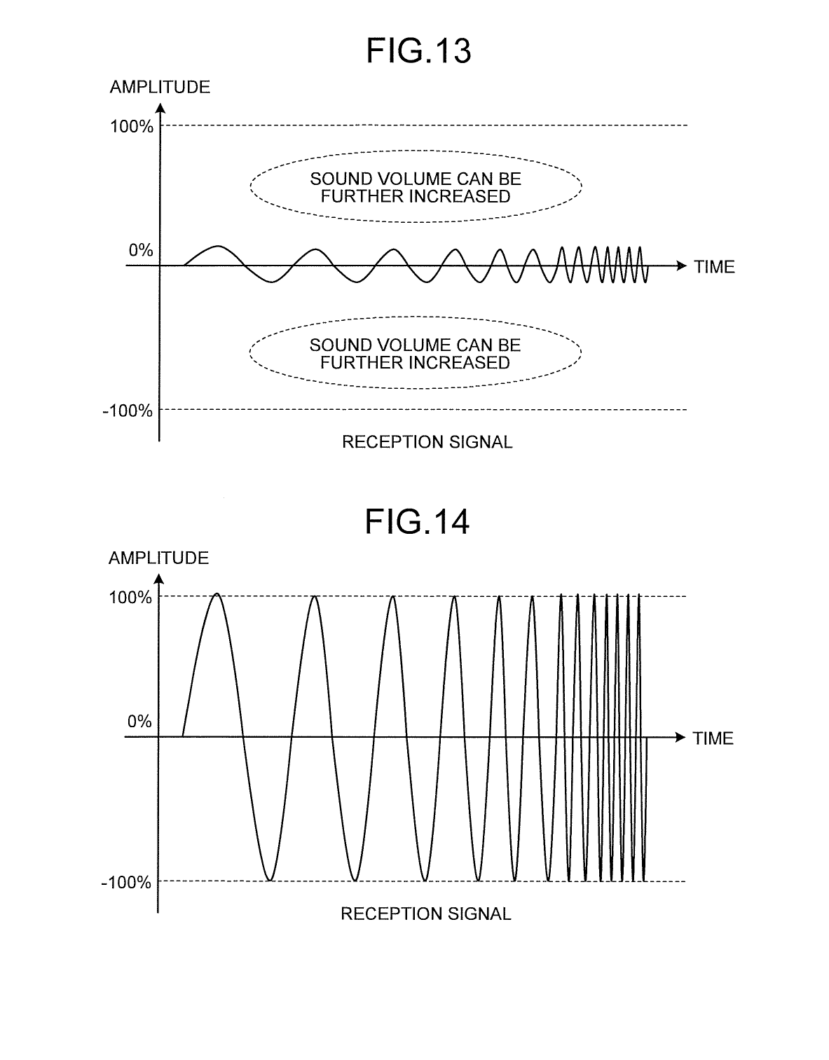

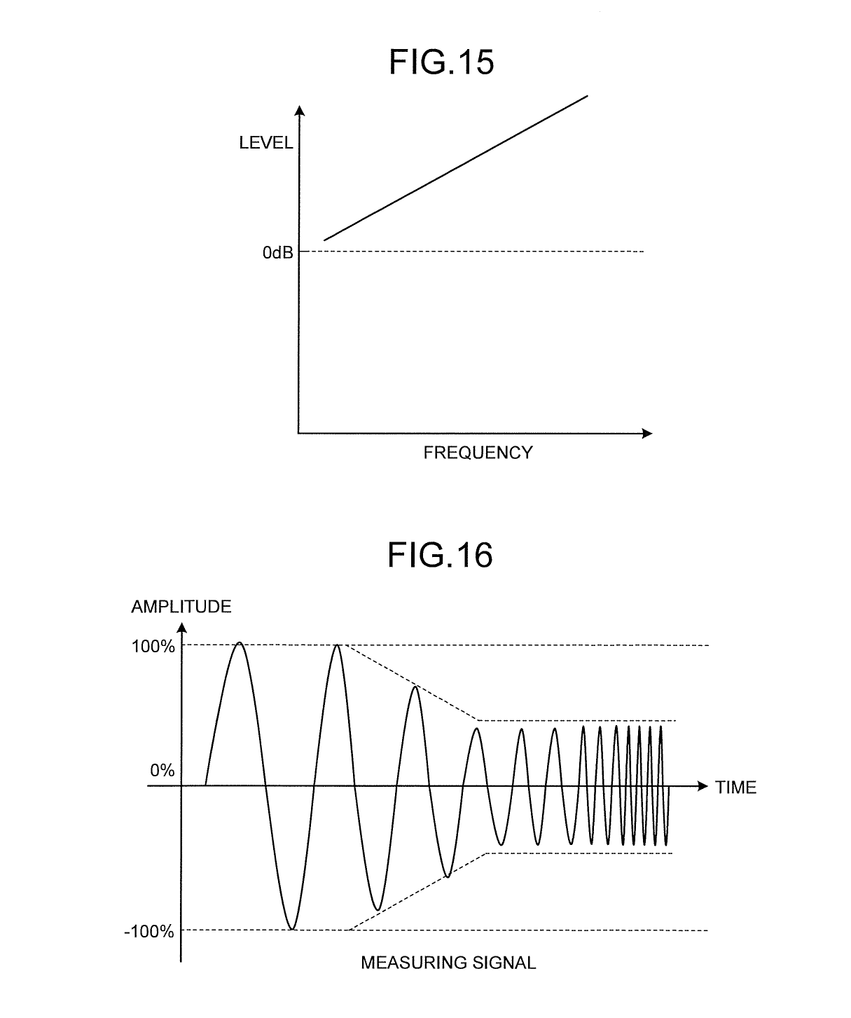

The TSP signal thus weighted is input to the high-pass system and output from the high-pass system, and the reception signal having no variation in amplitude as illustrated in FIG. 13 is obtained. In this case, it should be noted that a reproduction sound volume level and a receiving sound volume level are the same as those in a conventional method. In the low frequency range, the waveform having a small amplitude as the same as that of the conventional method is observed because the weight W(k) of the measuring signal is nearly equal to one. In the high frequency range, the waveform having the small amplitude is also observed because the amplitude of the measuring signal is suppressed by the weight W(k). If the waveform remains unchanged, the reception signal may be buried in noise over all frequency ranges. The waveform, however, is observed as the waveform illustrated in FIG. 14 by increasing the reproduction sound volume or the receiving sound volume, thereby enabling the measurement to be performed with a high gain both in the low frequency range and the high frequency range. The inverse TSP processing is performed on the reception signal and thereafter the frequency amplitude spectrum is obtained as the waveform illustrated in FIG. 15. In the low frequency range, the level is approximately 0 dB because the sound volume of the signal in the low frequency range is increased so as to compensate the drop of the gain of the measuring target system. In the high frequency range, the level does not exceed the maximum amplitude of the reception signal even if the gain of the measuring target system in the high frequency range is high because the amplitude of the signal in the high frequency range is set to be small in advance. The frequency amplitude characteristic having the level more than 0 dB is obtained because the reception signal is observed as a larger signal than the reproduction signal. The preliminary modification of the amplitude value of the TSP signal in accordance with the characteristic of the measuring target system enables the dynamic range of the reception signal to be effectively used, thereby enabling a signal in a band range, which is buried in noise due to its low receiving level, to be measured with a sufficient sound volume.

If the reproduction sound volume can be increased by the amplifier 222, the reception signal can be adjusted so as not to be overflowed by lowering the level of the receiving side without using the above-described technique. The adjustment can reduce noise superimposed in the measuring target system and a signal-to-noise (S/N) ratio may be increased even when the reception signal is faint in the low band range. However, in reality, sufficient performance cannot be obtained due to circuit noise superimposed after receiving the signal and quantization distortion, for example. Therefore, it is effective that the sufficient amplitude is obtained in the reception signal using the above-described technique. In the apparatus, which is not a measuring instrument, such as a personal computer or a smartphone, the level of the microphone is not changeable in many cases. In such a case, the level of the reproduction signal needs to be adjusted. The technique is also effective in this case.

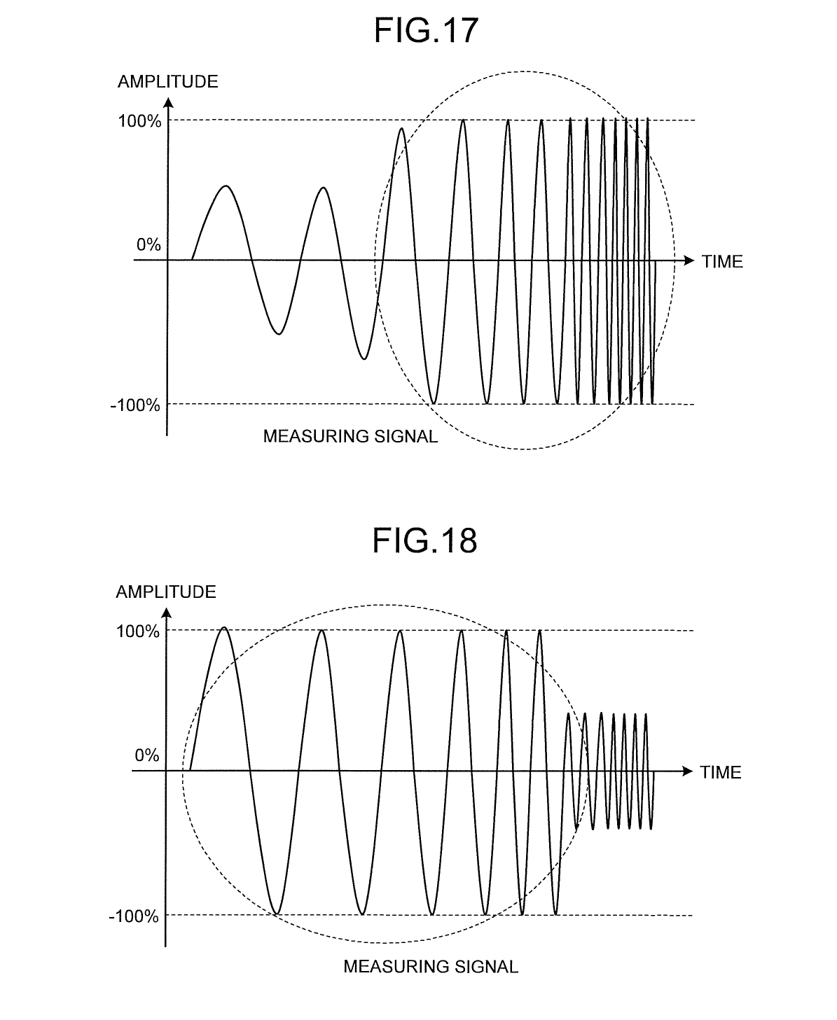

FIG. 16 illustrates a measuring signal obtained by controlling the amplitude of the TSP signal illustrated in FIG. 11 so as to flatten the amplitude in a predetermined range in the low frequency range and the high frequency range. If the level in the low frequency range is excessively increased, a problem may arise in that the distortion of the reproduction signal is increased. Therefore, it is effective to flatten the amplitude to a predetermined level. If the signal in the high frequency range is excessively decreased to a small level, a problem may arise in that the quantization distortion increases. Therefore, it is effective to set the lower limit of the amplitude of the measurement signal. The effect can be obtained by only processing either one of them.

When the TSP signal illustrated in FIG. 11 or 16 is used, a problem arises in that accuracy of the reproduction signal is reduced due to the quantization distortion because the amplitude of the signal in the high range is excessively reduced to a small level in the measuring target system of the high-pass system in which a level difference between the high and low ranges is larger than a predetermined level.

In order to solve such a problem, the media player 122 of the computer 10 serving as the measuring apparatus of the embodiment measures the frequency characteristic of the measuring target system (the sound-isolating earphone 200) using the following data stored in the HDD 111 as illustrated in FIG. 3: first TSP signal data 241A serving as a first measuring signal, and second TSP signal data 241B that serves as a second measuring signal and in which the amplitude in the low range is emphasized relative to that in the high range are stored, while storing first inverse TSP signal data 242A corresponding to the first TSP signal data 241A, and second inverse TSP signal data 242B corresponding to the second TSP signal data 241B. The amplitude in the low range is also referred to as the low-range amplitude while the amplitude in the high range is also referred to as the high-range amplitude.

For example, the TSP signal illustrated in FIG. 5 can be used as the first TSP signal data 241A. The first TSP signal data 241A is not limited to this example. It is needless to say that a TSP signal can be used in which a target frequency band range is weighted taking into consideration a variation in spectrum amplitude of the measuring target system (e.g., the sound-isolating earphone 200). For example, a weighted TSP signal illustrated in FIG. 17 can be used. As a result, the target frequency band range is limited to a predetermined range and a variation in spectrum amplitude of the measuring target system can be reduced in the frequency band range.

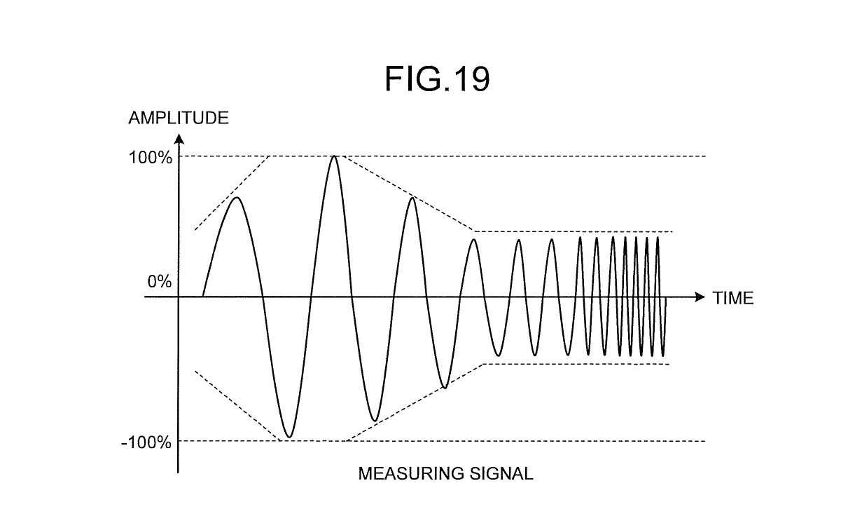

For example, the TSP signal illustrated in FIG. 18 or 19 can be used as the second TSP signal data 241B. The TSP signal illustrated in FIG. 16 can also be used as the second TSP signal data 241B. In those TSP signals, the amplitude in the low range is emphasized (weighted) relative to that in the high range. The emphasis of the low-range amplitude can be expressed as the suppression of the high-range amplitude. That is, they are relative expressions.

In the TSP signal illustrated in FIG. 19, the signal amplitude in the lowest range side is not emphasized while the amplitude in the low range is generally emphasized relative to that in the high range. That is, the signal amplitude in the lowest frequency range side is not emphasized, the range in which signals are hardly reproduced even though the sound volume is increased in a device of the measuring target system, thereby having an effect that the amplitude can be more efficiently emphasized in the low range.

In the media player 122 of the computer 10 serving as the measuring apparatus of the embodiment, the signal output module 231 supplies a first output signal corresponding to the first TSP signal data 241A and a second output signal corresponding to the second TSP signal data 241B in which the low frequency range amplitude is emphasized relative to the high-range amplitude to the sound-isolating earphone 200, which is the measuring target, temporally exclusively through the sound controller 106.

A time ordering for supplying the first output signal corresponding to the first TSP signal data 241A and the second output signal corresponding to the second TSP signal data 241B and reproducing them from the sound-isolating earphone 200, and the number of reproductions of each of the first TSP signal data 241A and the second TSP signal data 241B may be a predetermined order and a predetermined reproduction number of times. The second TSP signal data 241B may be reproduced earlier than the first TSP signal data 241A. For example, the first TSP signal data 241A may be reproduced continuously N times and thereafter the second TSP signal data 241B may be reproduced continuously M times. The measurement is performed with higher accuracy when the number of reproductions, i.e., N and M, is set to a plurality of times (e.g. around 4 to 10 times) rather than one time. However, with an increase in the number of reproductions (N and M), the measurement time becomes longer. The number of reproductions (N and M) may be set to an appropriate value depending on application.

Upon receiving the measurement signals based on the first output signal corresponding to the first TSP signal data 241A and the second output signal corresponding to the second TSP signal data 241B that are output from the sound controller 106, the impulse response computation module 233 performs computation of the impulse responses by convolving the measurement signal corresponding to the first TSP signal data 241A with the first inverse TSP signal data 242A serving as a first inverse measuring signal data, and the measurement signal corresponding to the second TSP signal data 241B with the second inverse TSP signal data 242B serving as a second inverse measuring signal data.

The frequency characteristic computation module 234 performs computation of the frequency characteristic data 235 representing an acoustic characteristic by synthesizing the respective frequency amplitude spectrums obtained by Fourier transforming the impulse responses corresponding to the first TSP signal data 241A and the second TSP signal data 241B.

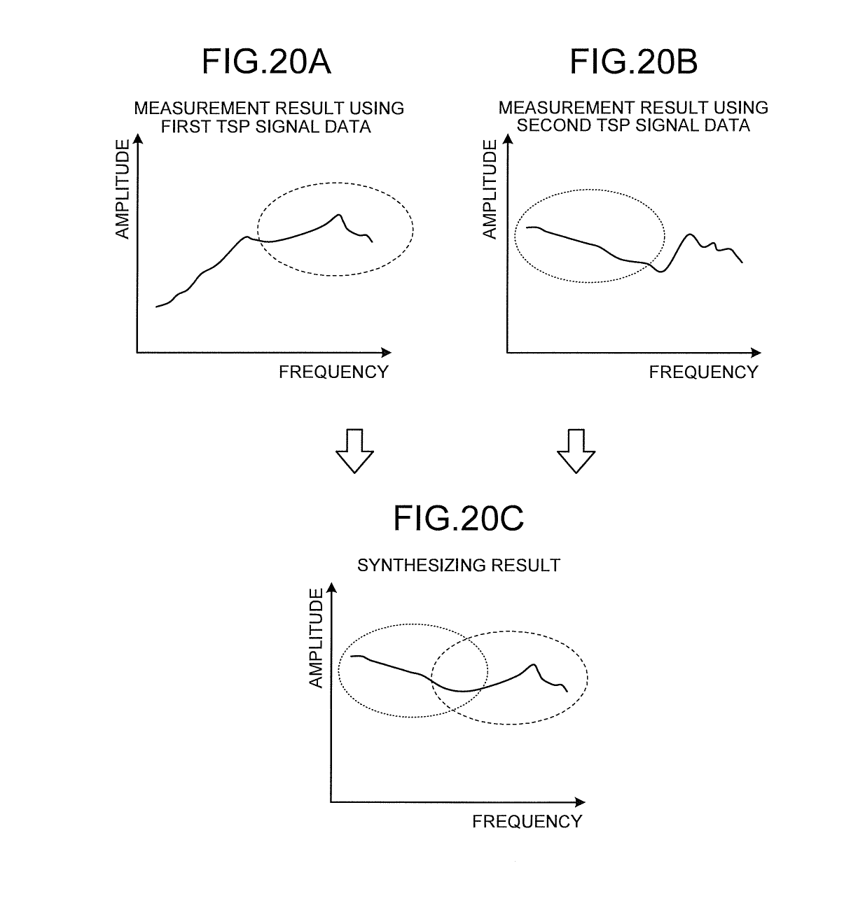

FIGS. 20A to 20C are schematic diagrams illustrating the synthesizing of the frequency amplitude spectrums in the frequency characteristic computation module 234. FIG. 20A illustrates an example of first measurement data of the acoustic characteristic obtained by converting the impulse response obtained using the first TSP signal data 241A into the frequency characteristic. FIG. 20B illustrates an example of second measurement data of the acoustic characteristic obtained by converting the impulse response obtained using the second TSP signal data 241B into the frequency characteristic. FIG. 20C illustrates an example of the frequency characteristic data 235 representing the acoustic characteristic after the synthesizing obtained by synthesizing the first measurement data and the second measurement data.

The frequency characteristic computation module 234 decreases a use proportion of the second measurement data and increases the use proportion of the first measurement data as the frequency increases in a predetermined frequency band range when synthesizing the first measurement data and the second measurement data, for example. In this way, in the frequency characteristic computation module 234, the synthesizing is performed by changing the allocation of the first measurement data and the second measurement data in a predetermined frequency band range used for the synthesizing, thereby suppressing discontinuity to occur at the synthesizing of data.

When the measuring apparatus is applied to measure the sound-isolating earphone 200 serving as the measuring target system, a frequency range of 400 to 900 Hz within a range from several hundred hertz to approximately one kilohertz, for example, can be used as the predetermined frequency band range used for the synthesizing. Such a predetermined frequency band range used for the synthesizing is set in accordance with the tendency of the variation in the frequency characteristic of the measuring target system, the weights of the first TSP signal data 241A and the second TSP signal data 241B, and the size of the signal.

The synthesizing of the frequency amplitude spectrums is described based on a specific example. The frequency characteristic computation module 234 fully uses the second measurement data in a frequency band range lower than a predetermined frequency band range, and gradually changes the allocation thereof from 100% to 0% from a lower frequency to a high frequency in the predetermined frequency band range, and does not use the second measurement data in a frequency band range higher than the predetermined frequency band range. The frequency characteristic computation module 234 uses the remaining balance after the allocation of the second measurement data as the first measurement data.

The synthesizing method is not limited to this example and the synthesizing can be performed by any method that synthesizes the first measurement data and the second measurement data by being complemented each other.

A correction filter, which is designed based on the frequency characteristic data 235 obtained by obtaining the measurement data of the frequency characteristic of the sound-isolating earphone 200 serving as the measuring target system using the first TSP signal data 241A and the second TSP signal data 241B and by synthesizing them, enables acoustic correction of the sound-isolating earphone 200 serving as the measuring target system to be properly performed.

A reproduction function of the media player 122 using the frequency characteristic of a sound output from the sound-isolating earphone 200 is described below. The reproduction function of the media player 122 has a correction function that causes a sound output from the sound-isolating earphone 200 to have a target frequency characteristic based on the measured frequency characteristic of the sound-isolating earphone 200.

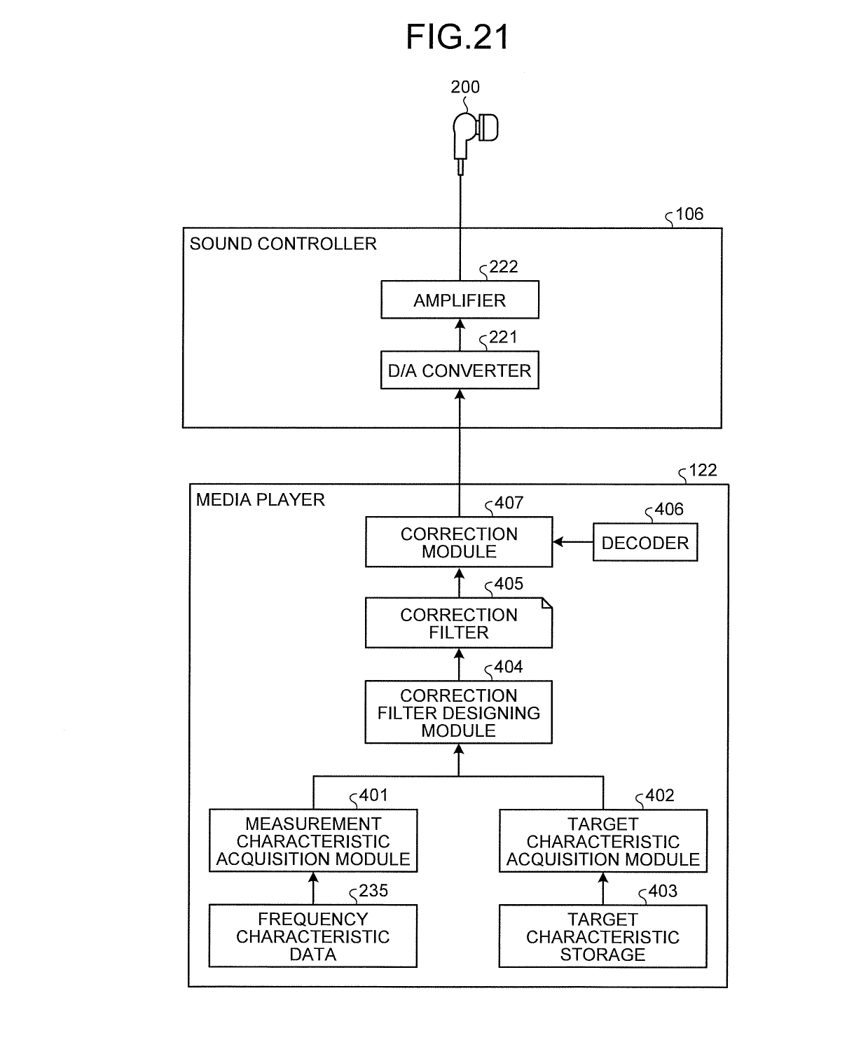

A structure of the correction function of the media player 122 is described below with reference to FIG. 21. As illustrated in FIG. 21, the media player 122 comprises a measurement characteristic acquisition module 401, a target characteristic acquisition module 402, a correction filter designing module 404, a decoder 406, and a correction module 407.

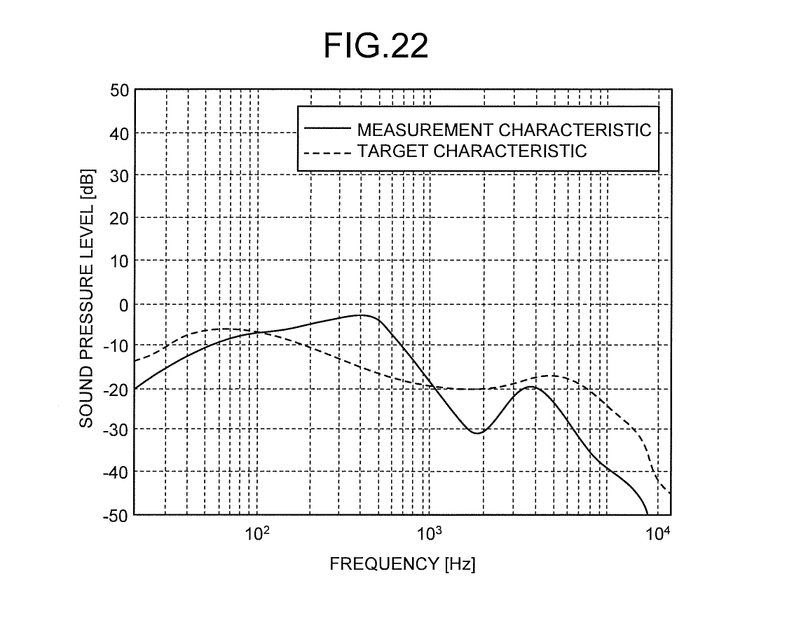

The measurement characteristic acquisition module 401 acquires the frequency characteristic data 235 produced by the frequency characteristic computation module 234. The target characteristic acquisition module 402 acquires from a target characteristic storage 403 target characteristic data representing a target frequency characteristic (hereinafter referred to as a target characteristic) of a sound reaching an eardrum. The target characteristic storage 403 stores therein a plurality of pieces of target characteristic data, for example. One of the pieces of target characteristic data represents an ideal frequency characteristic, for example. The other pieces of target characteristic data correspond to a plurality of music genres, for example. FIG. 22 illustrates an example of the frequency characteristic represented by the target characteristic data. The target characteristic acquisition module 402 acquires one piece of target characteristic data selected by a user out of the pieces of target characteristic data stored in the target characteristic storage 403.

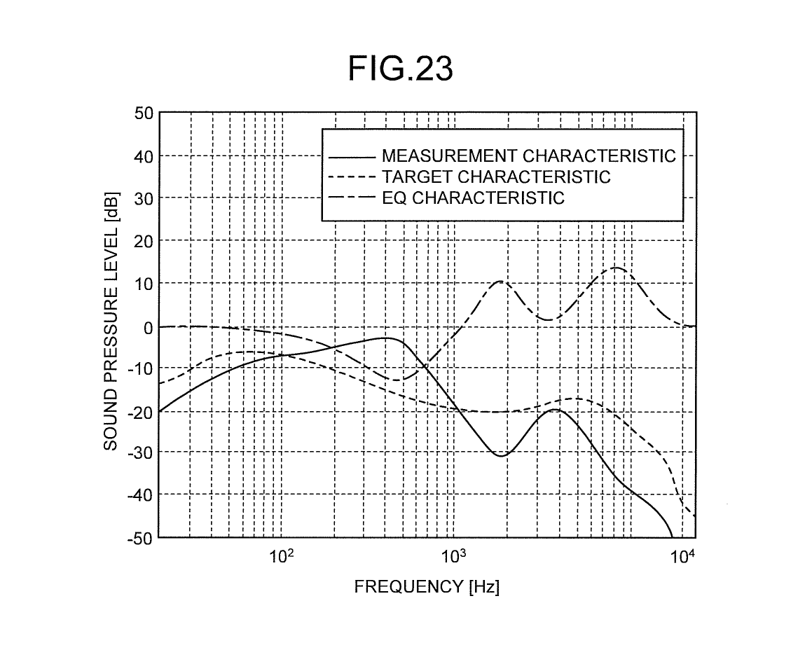

The correction filter designing module 404 designs a correction filter (correction data) 405 used for approximating the frequency characteristic data to the target characteristic based on the target characteristic data and the frequency characteristic data 235. FIG. 23 illustrates a frequency characteristic represented by the correction filter 405. The correction filter 405 comprises parameters used in a typical parametric equalizer. The parameters used in the parametric equalizer are a center frequency, a width of a band range to be adjusted, and a sound volume.

The decoder 406 produces audio data by decoding data coded in a compression format such as an MPEG-1 audio layer 3 (MP3). The correction module 407 corrects the audio data based on the correction filter 405 produced by the correction filter designing module 404. The corrected audio data is input to the D/A converter 221 of the sound controller 106. The D/A converter 221 converts the audio data into an electrical signal and outputs the converted electrical signal to the amplifier 222. The amplifier 222 amplifies the electrical signal and outputs the amplified electrical signal to the sound-isolating earphone 200.

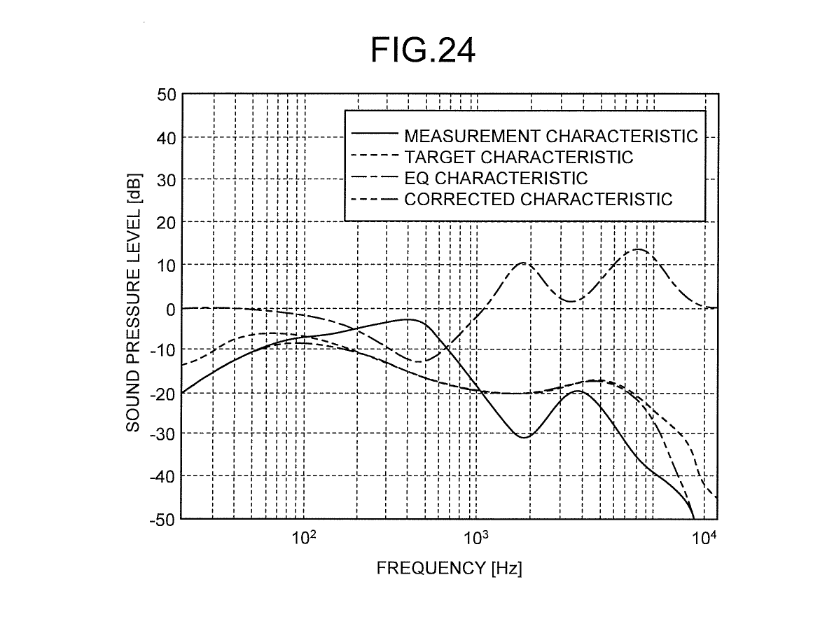

FIG. 24 illustrates a frequency characteristic (corrected characteristic) of a sound output from the sound-isolating earphone 200. As illustrated in FIG. 24, the corrected characteristic approximately coincides with the target characteristic.

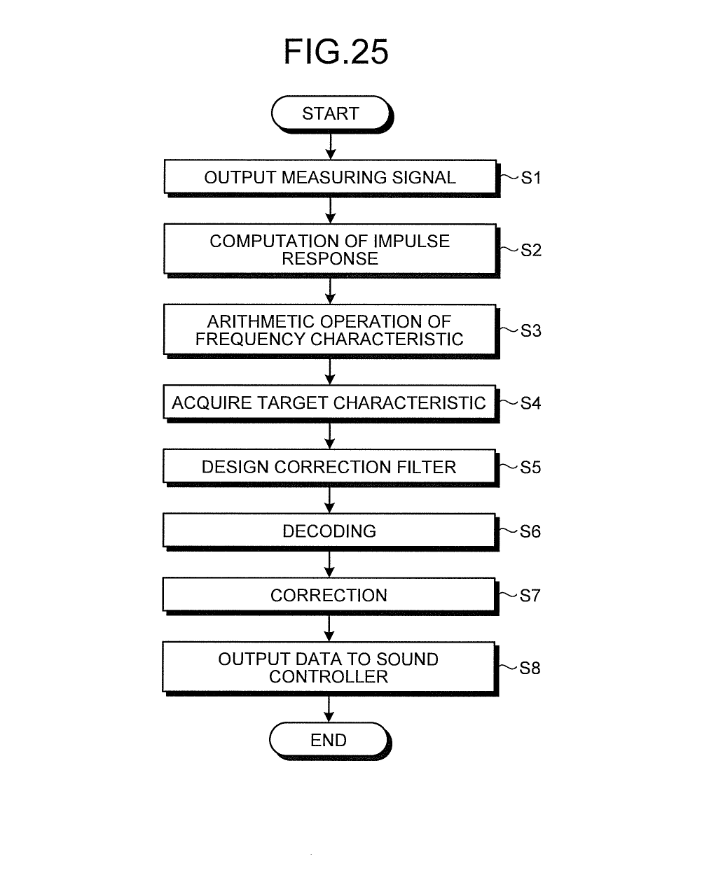

With reference to FIG. 25, a procedure is described below in which the media player 122 activated in the computer 10 measures the frequency characteristic of a sound output from the sound-isolating earphone 200 and corrects the sound to be output from the sound-isolating earphone 200 based on the measured frequency characteristic.

The signal output module 231 outputs a measuring signal to the sound controller 106 so as to cause the sound-isolating earphone 200 to output a measuring sound (the first output signal corresponding to the first TSP signal data 241A or the second output signal corresponding to the second TSP signal data 241B) (S1).

The sound controller 106 receives the sound output from the sound-isolating earphone 200 by the microphone 113 and outputs a reception signal (a first reception signal or a second reception signal) to the media player 122. The reception signal (the first reception signal or the second reception signal) is supplied to the impulse response computation module 233.

The impulse response computation module 233 performs computation of the impulse response by convolving the reception signal with the first inverse TSP signal data 242A or the second inverse TSP signal data 242B, and supplies the resulting impulse response to the frequency characteristic computation module 234 (S2).

The frequency characteristic computation module 234 performs computation of the respective frequency amplitude spectrums by Fourier transforming the impulse responses corresponding to the first TSP signal data 241A and the second TSP signal data 241B, and then performs computation of the frequency characteristic data 235 representing the acoustic characteristic by synthesizing the frequency amplitude spectrums (S3).

Then, the target characteristic acquisition module 402 acquires the target characteristic data from the target characteristic storage 403 (S4), and thereafter the correction filter designing module 404 designs the correction filter 405 based on the frequency characteristic data 235 and the target characteristic data (S5).

Then, the decoder 406 decodes compression-encoded music data (S6). The correction module 407 corrects the decoded music data based on the correction filter 405 (S7) and outputs the corrected music data to the sound controller 106 (S8).

Upon receiving the corrected music data, the sound controller 106 converts the music data into a music signal, amplifies the converted music signal, and outputs the amplified music signal to the sound-isolating earphone 200.

The following processing can be performed: the processing from S1 to S5 is performed and parameters of the designed correction filter are stored, and the parameters are read when the music is reproduced, and thereafter the processing starts at S5. Because the characteristic of the measuring target system (the sound-isolating earphone 200) does not greatly vary, the parameters of the correction filter can be used after the parameters are obtained by performing the processes in the first half of the procedure one time, thereby enabling the measurement processes to be skipped.

According to the embodiment, sounds are heard as sounds similar to those output from an ideal sound-isolating earphone 200 when heard by the sound-isolating earphone 200. As a result, a user can enjoy music with high sound quality when reproducing the music using the sound-isolating earphone 200, for example. In addition, even if the sound-isolating earphone 200 is inexpensive and thus has no good characteristic, a user can simply correct the characteristic of the sound-isolating earphone 200 by himself.

A coefficient of the correction filter is designed by comparing the measured frequency characteristic of the sound-isolating earphone 200 with the characteristic of the ideal earphone. This means that a filter bridging the characteristic difference between the two earphones is designed. Accordingly, when the same fluctuation is added to the two characteristics, no fluctuation appears in the difference.

In this way, according to the embodiment, even when an average frequency characteristic of the measuring target system (e.g., the sound-isolating earphone 200) greatly varies in frequency, measurement can be performed with higher accuracy than the conventional method in the following manner. The first measurement data is obtained from the first TSP signal data 241A and the second measurement data is obtained from the second TSP signal data 241B in which the low-range amplitude is emphasized relative to the high-range amplitude (TSP signal in which amplitude components are controlled taking the average frequency characteristic into consideration). Then, the frequency characteristic data 235 is obtained by synthesizing the first measurement data and the second measurement data.

The signal output module 231 may set a gain (first gain) with respect to the first TSP signal data 241A and a gain (second gain) with respect to the second TSP signal data 241B to different values from each other in synchronization with the respective TSP signals. The gain can be achieved by controlling the amplifier or volume setting of the media player 122, for example. This structure has an effect that a proper value can be set to each of the first TSP signal data 241A and the second TSP signal data 241B so as to improve a signal-to-noise ratio (SNR) of the reception signal in accordance with the shapes and sizes of the weights of the respective TSP signals and a variation tendency of the frequency characteristic of the measuring target system, for example.

For example, when the first TSP signal data 241A and the second TSP signal data 241B in which the low-range amplitude is emphasized relative to the high-range amplitude are used for the measuring target system (the sound-isolating earphone 200) of the high-pass system, this structure has an effect that the SNR of the reception signal measured using the second TSP signal data 241B can be improved by setting the second gain to be larger than the first gain. In this case, the first gain does not need to be increased in the manner as the second gain, thereby having an effect that the reception signal measured using the first TSP signal data 241A can be prevented from being distorted due to an excessive amplitude.

In the embodiment, the computation of the frequency amplitude spectrum is performed by Fourier transforming the impulse response obtained by convolving the measurement signal with the inverse TSP signal data 242, which is obtained by inverting the TSP signal data 241 in chronological order (by performing convolution computation on the measurement signal and the inverse TSP signal data 242). The computation, however, is not limited to this manner. For example, the reception signal is converted into a frequency domain and an effect of the weight is removed (e.g., conjugate inverse of W(k) is multiplied) in the frequency domain because whether the weight W(k) is weighted to the TSP signal corresponding to the reception signal is known. As a result, the frequency amplitude spectrum of the measuring target system obtained from the reception signal can be obtained. In such a case where the processing to obtain the impulse response is not used, the inverse TSP signal is not required.

In the embodiment, the measuring target system is the sound-isolating earphone 200. The measuring target system, however, is not limited to the sound-isolating earphone 200. Various earphones and headphones are applicable as the measuring target system.

The media player 122 (application program) executed by the computer 10 of the embodiment is recorded into a storage medium readable by a computer in a format installable in or a file executable by the computer, and provided. The examples of the storage medium comprise a compact disk ROM (CD-ROM), a flexible disk (FD), a CD-recordable (CD-R), and a digital versatile disk (DVD).

The media player 122 (application program) executed by the computer 10 of the embodiments may be stored in a computer coupled with a network such as the Internet, and be provided by being downloaded through the network. The media player 122 (application program) executed by the computer 10 of the embodiment may be provided or delivered through a network such as the Internet.

The media player 122 (application program) of the embodiment may be provided by being preliminarily stored in the ROM, for example.

The media player 122 (application program) executed by the computer 10 of the embodiment has a module structure comprising the above-described modules (the signal output module 231, the impulse response computation module 233, and the frequency characteristic computation module 234). In actual hardware, the CPU (processor) reads the media player 122 (application program) from the above-described storage medium and executes the media player 122. Once the media player 122 is executed, the above-described modules are loaded into a main storage, and the signal output module 231, the impulse response computation module 233, and the frequency characteristic computation module 234 are formed in the main storage.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measuring apparatus comprising:
an output module configured to temporally exclusively output, to a measuring target system, a first output signal corresponding to a first measuring signal for sweeping frequency and a second output signal corresponding to a second measuring signal for sweeping frequency and having a different amplitude characteristic from an amplitude characteristic of the first measuring signal; and
a frequency characteristic computation module configured to synthesize a first frequency amplitude spectrum obtained from a first reception signal when a sound output from the measuring target system based on the first output signal is received and a second frequency amplitude spectrum obtained from a second reception signal when a sound output from the measuring target system based on the second output signal is received to generate frequency characteristic data representing an acoustic characteristic.

2. The measuring apparatus of claim 1, wherein
the output module is configured to use, as the second measuring signal, a signal having modified amplitude in a predetermined frequency band range in accordance with a characteristic of the measuring target system, and
the frequency characteristic computation module is configured to synthesize the first frequency amplitude spectrum and the second frequency amplitude spectrum using the second frequency amplitude spectrum in the predetermined frequency band range.

3. The measuring apparatus of claim 2, wherein
the measuring target system is a high-pass system in which an observed sound becomes smaller as frequency is decreased in a low range, and
in the second measuring signal that is a base of the second output signal output by the output module, a low-range amplitude is emphasized relative to a high-range amplitude.

4. The measuring apparatus of claim 2, wherein the frequency characteristic computation module is configured to perform the synthesizing by fully using the second frequency amplitude spectrum in a frequency band range lower than the predetermined frequency band range, gradually changing an allocation of the second frequency amplitude spectrum from 100% to 0% from a low frequency to a high frequency in the predetermined frequency band range, and not using the second frequency amplitude spectrum in a frequency band range higher than the predetermined frequency band range while using a remaining balance after the allocation of the second frequency spectrum as the first frequency amplitude.

5. The measuring apparatus of claim 1, wherein the output module continuously is configured to output, to the measuring target system, one of the first output signal and the second output signal predetermined times, and thereafter continuously output the other of the first output signal and the second output signal predetermined times.

6. The measuring apparatus of claim 1, wherein
the output module comprises a first gain with respect to the first output signal and a second gain with respect to the second output signal, and is configured to set different values from each other to the first gain and the second gain in synchronization with the first measuring signal and the second measuring signal.

7. The measuring apparatus of claim 1, wherein the first measuring signal and the second measuring signal are sinusoidal sweep signal data whose frequency continuously changes with time.

8. The measuring apparatus of claim 7, wherein the sinusoidal sweep signal data is time stretched pulse (TSP) signal data.

9. A computer program product having a non-transitory computer readable medium including programmed instructions, wherein the instructions, when executed by a computer, cause the computer to perform:
temporally exclusively outputting, to a measuring target system, a first output signal corresponding to a first measuring signal for sweeping frequency and a second output signal corresponding to a second measuring signal for sweeping frequency and having a different amplitude characteristic from an amplitude characteristic of the first measuring signal; and
synthesizing a first frequency amplitude spectrum obtained from a first reception signal when a sound output from the measuring target system based on the first output signal is received and a second frequency amplitude spectrum obtained from a second reception signal when a sound output from the measuring target system based on the second output signal is received to generate frequency characteristic data representing an acoustic characteristic.

10. The computer program of claim 9, wherein
the outputting includes using, as the second measuring signal, a signal having modified amplitude in a predetermined frequency band range in accordance with a characteristic of the measuring target system, and
the synthesizing includes synthesizing the first frequency amplitude spectrum and the second frequency amplitude spectrum using the second frequency amplitude spectrum in the predetermined frequency band range.
